(19) United States
(12) Patent Application Publication
(10) Pub. No.: US 2017/0303074 A1
(43) Pub. Date: Oct. 19, 2017

(54) BLUETOOTH PERSONNEL LOCATION SYSTEM

(71) Applicant: Yu-Shun Lin, NEW TAIPEI CITY (TW)

(72) Inventor: Yu-Shun Lin, NEW TAIPEI CITY (TW)

(21) Appl. No.: 15/484,139

(22) Filed: Apr. 11, 2017

(30) Foreign Application Priority Data
Apr. 14, 2016 (TW) 105111610

(51) Int. Cl. H04W 4/00; G01K 3/08; H04B 17/318; H04W 4/02

(52) U.S. Cl. CPC H04W 4/008; G01K 3/08; H04B 17/318; H04W 4/02

(57) ABSTRACT

The present invention discloses a Bluetooth personnel location system for positioning a personnel coordinate position. The Bluetooth personnel location system comprises a Bluetooth wearable device, a plurality of Bluetooth wireless base stations, and a positioning server. The Bluetooth wearable device is worn by a predetermined positioning person for sending regularly a plurality of Bluetooth broadcast signals. Each Bluetooth broadcast signal comprises a measured temperature for the predetermined positioning person. The positioning server is for receiving the Bluetooth broadcast signals and the signal strength of the Bluetooth broadcast signals through the Bluetooth wireless base stations. According to the Bluetooth broadcast signals and the signal strength, the positioning server can determine whether the Bluetooth wearable device is wearing by the predetermined positioning person or not and the location of the predetermined positioning person.

### BACKGROUND OF THE INVENTION

### Field of the Invention

The present invention relates to a positioning system, more particularly, to a Bluetooth personnel location system that is positioned by using a Bluetooth wearable device.

### Description of the Prior

With the development of communication methods, wireless communication technology has replaced traditional wired telephones and letters. The wireless positioning system is derived from the wireless communication technology, and the wireless positioning system is one of the very important applications. A common positioning system such as Global Positioning System (GPS) forms a positioning system via the wireless communication between the GPS locator and the satellite.

GPS and WiFi are currently used in positioning in life. GPS needs to be used with satellite signals. GPS often cannot be used in the basement or garage, and cannot be vertically positioned. WiFi needs to have a base station in the case of the signal, and the error rate is higher. Whether GPS or WiFi positioning are required to have satellite signals or base station signal transmission to position. The present invention adopts the Bluetooth positioning method to improve the precision and reduce the equipment demand.

In the prior art, a Bluetooth positioning system may be used to monitor whether a target is going near or away. When the receiving end receives the Bluetooth broadcast signal of the target, the receiving end can determine whether the target is close to or away from the receiving end by the strength change of the Bluetooth broadcasting signal, and then produce a message to inform the supervisor.

In another prior art, a Bluetooth positioning system can track the position of a Bluetooth transmitting end by a plurality of Bluetooth receiving ends. The transmitting end may be a portable personal mobile electronic device, and the prior art of the positioning system locates the user by using the same position of the Bluetooth transmitting end as the user.

In the above-mentioned prior art, the Bluetooth positioning system cannot provide an effective method for determining whether the Bluetooth transmitting end is out of the predetermined people or not, resulting in ineffective positioning.

Thus, the above-mentioned prior art is not a good design, and still, a lot of missing needs to be improved. In view of the above, the present invention will propose a Bluetooth personnel location system for effective positioning.

### SUMMARY OF THE INVENTION

An object of the present invention is to provide a Bluetooth personnel location system. In an embodiment of the present invention, the Bluetooth personal positioning system of the present invention is used for positioning a coordinate position of a predetermined people. The Bluetooth personal positioning system comprises a Bluetooth wearable device, a plurality of Bluetooth wireless base stations and a positioning server. The Bluetooth wearable device is worn by the predetermined people for sending a plurality of Bluetooth broadcasting signals. The plurality of Bluetooth wireless base stations is used for receiving the Bluetooth broadcasting signals, calculating a plurality of corresponding received signal strength indication according to the Bluetooth broadcasting signals, and sending the Bluetooth broadcasting signals and the received signal strength indication. The positioning server is used for receiving the Bluetooth broadcasting signals and the received signal strength indication to calculate the coordinate position of the predetermined people. Wherein, the Bluetooth wearable device comprises a temperature sensor and a heat conducting unit. The heat conducting unit is used for contacting with the skin of the predetermined people, and the temperature sensor is used for measuring the temperature of the heat conducting unit to produce a temperature value.

In another embodiment of the present invention, the Bluetooth personal positioning system of the present invention is used for positioning a coordinate position of a predetermined people. The Bluetooth personal positioning system comprises a Bluetooth wearable device, a plurality of Bluetooth wireless base stations, a plurality ambient temperature sensor and a positioning server. The Bluetooth wearable device is worn by the predetermined people for sending a plurality of Bluetooth broadcasting signals. The plurality of Bluetooth wireless base stations is used for receiving the Bluetooth broadcasting signals, calculating a plurality of corresponding received signal strength indication according to the Bluetooth broadcasting signals, and sending the Bluetooth broadcasting signals and the received signal strength indication. The ambient temperature sensor measures the ambient temperature and transmits an ambient temperature signal to the positioning server. The positioning server is used for receiving the Bluetooth broadcasting signals, the received signal strength indication and the ambient temperature signal to calculate the coordinate position of the predetermined people. Wherein, the Bluetooth wearable device comprises a temperature sensor and a heat conducting unit. The heat conducting unit is used for contacting with the skin of the predetermined people and the temperature sensor is used for measuring the temperature of the heat conducting unit to produce a temperature value.

In addition, when the temperature difference value between the Bluetooth wearable device and the ambient temperature sensor is less than the error value of the two measuring devices, the positioning server can determine that the user has not worn the Bluetooth wearable device to avoid an invalid positioning coordinate is generated.

Compared to the prior art, the Bluetooth personnel location system of the present invention utilizes the Bluetooth wearable device to send a plurality of Bluetooth broadcasting signals and calculate the position of the persons based on the received signal strength indication of the Bluetooth broadcasting signals. The Bluetooth personnel location system utilizes the temperature sensor of the Bluetooth wearable device to determine the wearing condition of the personnel to ensure the correctness of the positioning result.

The advantages and spirit of the invention may be further understood by the following detailed description of the invention and the appended drawings.

BRIEF DESCRIPTION OF THE APPENDED DRAWINGS

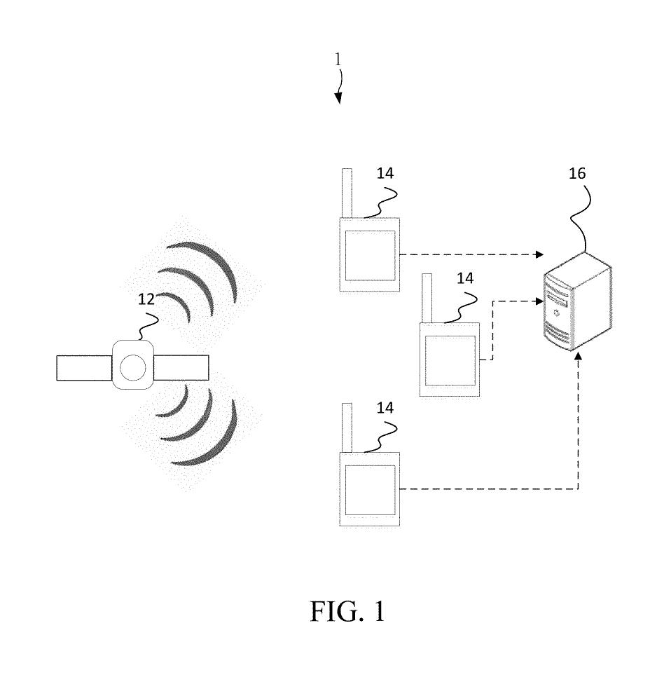

FIG. 1 shows a schematic diagram of the Bluetooth personnel location system in the first embodiment of the present invention.

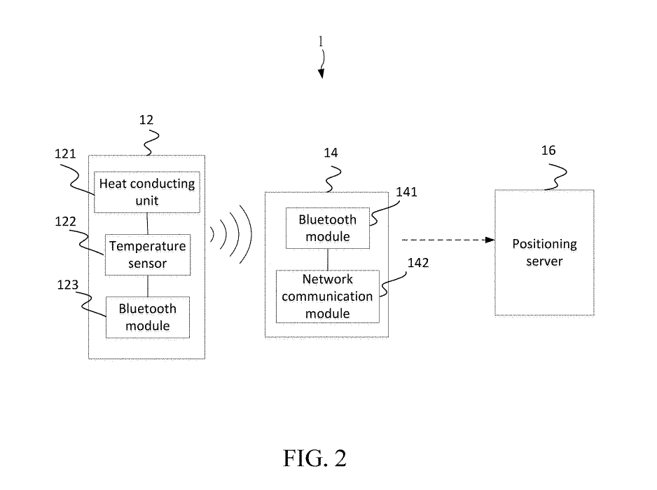

FIG. 2 shows a functional block diagram of the Bluetooth personnel location system in the first embodiment of the present invention.

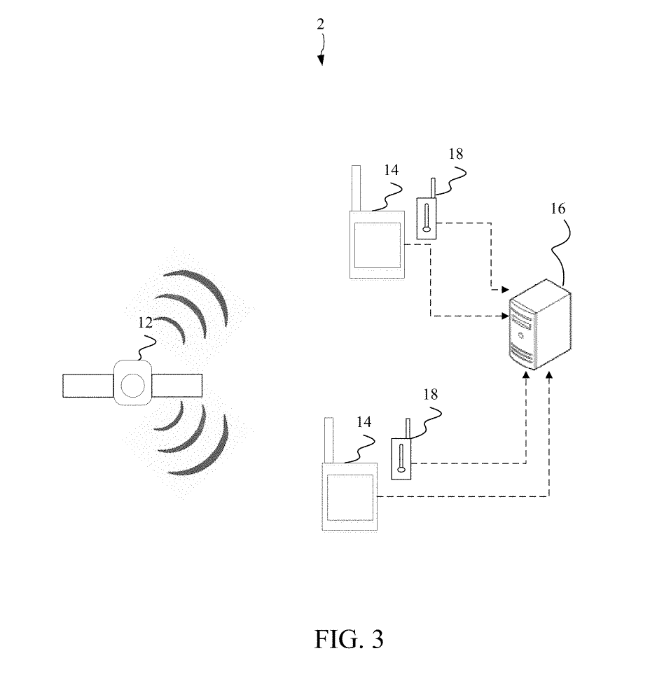

FIG. 3 shows a schematic diagram of the Bluetooth personnel location system in the second embodiment of the present invention.

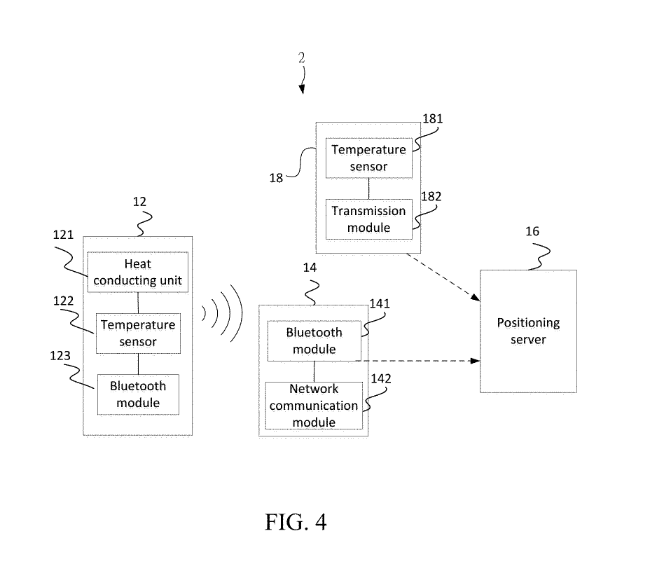

FIG. 4 shows a functional block diagram of the Bluetooth personnel location system in the second embodiment of the present invention.

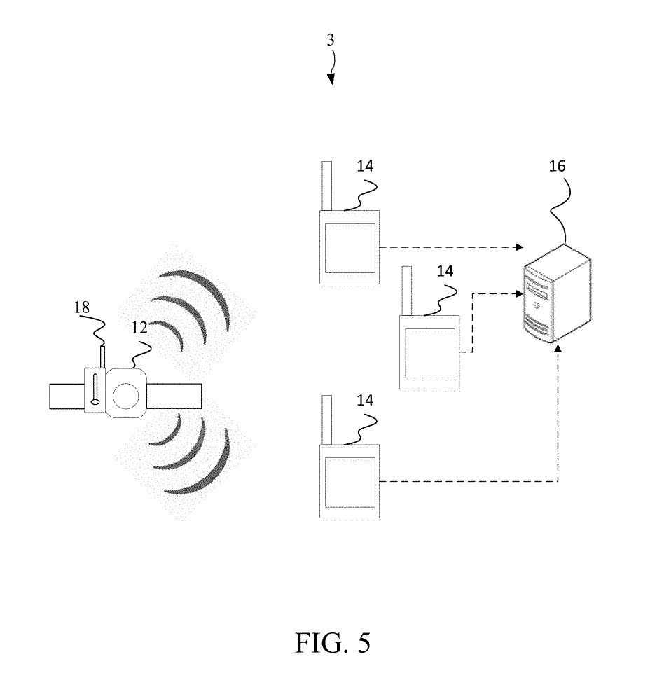

FIG. 5 shows a schematic diagram of the Bluetooth personnel location system in the third embodiment of the present invention.

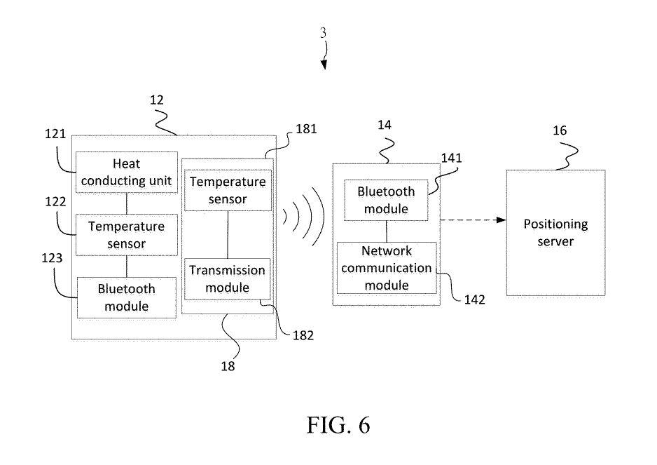

FIG. 6 shows a functional block diagram of the Bluetooth personnel location system in the third embodiment of the present invention.

### DETAILED DESCRIPTION OF THE INVENTION

A detailed description of the hereinafter described embodiments of the disclosed apparatus and method are presented herein by way of exemplification and not limitation with reference to the Figures. Although certain embodiments are shown and described in detail, it should be understood that various changes and modifications can be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention.

Please refer to FIG. 1 and FIG. 2. FIG. 1 shows a schematic diagram of the Bluetooth personnel location system 1 in the first embodiment of the present invention. FIG. 2 shows a functional block diagram of the Bluetooth personnel location system 1 in the first embodiment of the present invention. In the first embodiment of the present invention, the Bluetooth personnel location system 1 comprises a Bluetooth wearable device 12, a plurality of Bluetooth wireless base stations 14 and a positioning server 16. The Bluetooth wearable device 12 is worn by the predetermined people for sending a plurality of Bluetooth broadcasting signals. The plurality of Bluetooth wireless base stations 14 is used for receiving the Bluetooth broadcasting signals, calculating a plurality of corresponding received signal strength indication according to the Bluetooth broadcasting signals, and sending the Bluetooth broadcasting signals and the received signal strength indication. The positioning server 16 is used for receiving the Bluetooth broadcasting signals and the received signal strength indication to calculate the coordinate position of the predetermined people.

Wherein, the Bluetooth wearable device 12 comprises a Bluetooth module 123, a heat conducting unit 121 and a temperature sensor 122. The Bluetooth module 123 is used for sending a plurality of Bluetooth broadcasting signals periodically, and each Bluetooth broadcasting signal comprises a unique identification code of the Bluetooth wearable device 12 and the temperature value measured by the temperature sensor 122. The heat conducting unit 121 is used for contacting with the skin of the predetermined people. The temperature sensor 122 is used for measuring the temperature of the heat conducting unit 121 to produce a temperature value.

In addition, a plurality of Bluetooth wireless base stations 14 is configured around the predetermined people, and these Bluetooth wireless base stations 14 can measure a received signal strength indication (RSSI) when they receive a Bluetooth broadcasting signal. The Bluetooth wireless base stations 14 sends the received Bluetooth broadcasting signal and the received signal strength indication to the positioning server 16. The positioning server 16 calculates the coordinate position of the predetermined people according to the received signal strength indication.

In the practical application, the Bluetooth wireless base station 14 comprises a Bluetooth module 141 and a network communication module 142, and the Bluetooth wireless base station 14 receives the Bluetooth broadcasting signals sent from the Bluetooth wearable device 12 via the Bluetooth module 141 and calculates the received signal strength indication of the Bluetooth broadcasting signals, and transmits to the positioning server 16 via the network communication module 142. The network communication module 142 can be Bluetooth, Ethernet, Wi-Fi or wireless mobile communication module or other wired and wireless network module for communication.

The positioning server 16 can calculate the coordinate position of the Bluetooth device 12 according to the unique identification code in the Bluetooth broadcasting signal and the received signal strength indication (RSSI) sent from the plurality of Bluetooth wireless base station 14 and compare to the position of these Bluetooth wireless base stations 14. Positioning methods can be used as a single point Proximity Method such as Apple iBeacon positioning; or to use the three-point positioning, the multi-point positioning or the cellular positioning by the distance of the RSSI converted.

In the practical application, the positioning server 16 determines whether the Bluetooth wearable device 12 is worn on or out of the predetermined people according to whether the temperature value of the Bluetooth broadcasting signal is between a range from the standard temperature range of human body adding an error of the temperature sensor 122 and a temperature decay of the heat conducting unit 121.

Please refer to FIG. 3 and FIG. 4. FIG. 3 shows a schematic diagram of the Bluetooth personnel location system 2 in the second embodiment of the present invention. FIG. 4 shows a functional block diagram of the Bluetooth personnel location system 2 in the second embodiment of the present invention. In the second embodiment of the present invention, the Bluetooth personnel location system 2 comprises a Bluetooth wearable device 12, a plurality of Bluetooth wireless base stations 14, a positioning server 16 and an ambient temperature sensor 18. The Bluetooth wearable device 12 is worn by the predetermined people for sending a plurality of Bluetooth broadcasting signals. The plurality of Bluetooth wireless base stations 14 is used for receiving the Bluetooth broadcasting signals, calculating a plurality of corresponding received signal strength indication according to the Bluetooth broadcasting signals, and sending the Bluetooth broadcasting signals and the received signal strength indication to the positioning server 16. The ambient temperature sensor 18 measures the ambient temperature in the vicinity of the Bluetooth wireless base stations 14 and transmits a temperature signal to the positioning server 16. The positioning server 16 is used for receiving the Bluetooth broadcasting signals and the received signal strength indication from the Bluetooth wireless base stations 14, and receiving the temperature signal from the ambient temperature sensor 18 to compare and calculating the coordinate position of the predetermined people.

The ambient temperature sensor 18 comprises a temperature sensing module 181 and a transmission module 182. The transmission module 182 transmits the room temperature measured by the temperature sensing module 181 to the positioning server 16. When the positioning server 16 receives the temperature value measured by the temperature sensor 122 of the Bluetooth wearable device 12 and the room temperature value measured by the temperature sensing module 181, the positioning server 16 compares the temperature value and the room temperature value to get a temperature difference value. When the temperature difference value between the temperature value and the room temperature value is less than the cumulative error range, the positioning server 16 determines that the Bluetooth wearable device 12 is out of the predetermined people. Wherein, the transmission module 182 can be Bluetooth, Ethernet, Wi-Fi or wireless mobile communication module or other wired and wireless network module for communication.

In the practical application, when the temperature difference value measured by the temperature sensor 122 and the temperature sensing module 181 is less than the cumulative error range, the positioning server 16 may cooperate with the monitoring system to determine whether the Bluetooth wearable device 12 is still in the predetermined people.

Please refer to FIG. 5 and FIG. 6. FIG. 5 shows a schematic diagram of the Bluetooth personnel location system 3 in the third embodiment of the present invention. FIG. 6 shows a functional block diagram of the Bluetooth personnel location system 3 in the third embodiment of the present invention. In the third embodiment of the present invention, the Bluetooth personnel location system 3 comprises a Bluetooth wearable device 12, a plurality of Bluetooth wireless base stations 14, a positioning server 16. The Bluetooth wearable device 12 is worn by the predetermined people for sending a plurality of Bluetooth broadcasting signals. The plurality of Bluetooth wireless base stations 14 is used for receiving the Bluetooth broadcasting signals, calculating a plurality of corresponding received signal strength indication according to the Bluetooth broadcasting signals, and sending the Bluetooth broadcasting signals and the received signal strength indication to the positioning server 16. The positioning server 16 is used for receiving the Bluetooth broadcasting signals and the received signal strength indication from the Bluetooth wireless base stations 14, and receiving the temperature signal from the ambient temperature sensor 18 to compare and calculating the coordinate position of the predetermined people.

Wherein, the Bluetooth wearable device 12 comprises an ambient temperature sensor 18. The ambient temperature sensor 18 measures the ambient temperature outside the Bluetooth wearable device 12 by the internal temperature sensing module 181. The ambient temperature sensor 18 transmits the ambient temperature signal to the transmission module 182 in electrical connection, and the transmission module 182 transmits the signal to the Bluetooth wireless base stations. The transmission module 182 may be a Bluetooth module 123.

In the above-mentioned embodiments, the Bluetooth broadcasting signal comprises a unique identification code of the Bluetooth wearable device 12, the temperature value measured by the temperature sensor and the ambient temperature measured by the ambient temperature sensor 18. The heat conducting unit 121 is used for contacting with the skin of the predetermined people. The temperature sensor 122 is used for measuring the temperature of the heat conducting unit 121 to produce a temperature value.

In the practical application, the Bluetooth personnel location system 3 of the present invention can be applied to an emergency evacuation system. The Bluetooth wireless base stations 14 of the Bluetooth personnel location system 3 can be installed on various floors of a building or factory, and the Bluetooth personnel location system 3 can monitor the current location of each user. When the personnel to be evacuated needs to be fully evacuated due to an emergency, the Bluetooth personnel location system 3 detects that the person has not yet been evacuated from the building. The positioning server 16 can determine whether the person has not yet been evacuated is still wearing the Bluetooth wearable device 12 or not by the temperature difference value of the temperature sensor 122 of the Bluetooth wearable device 12 and the temperature sensing module 181 of the ambient temperature sensor 18. If the person has not yet been evacuated is still wearing the Bluetooth wearable device 12, the Bluetooth wireless base stations 14 of each floor of the Bluetooth personnel location system 3 can be used to locate the correct floor and location of the unopened person for rescue.

In the practical application, the Bluetooth personnel location system 3 of the present invention can be applied to a baby room of a hospital or a post-natal care home. A plurality of Bluetooth wireless base stations 14 are deployed in a hospital or post-natal care home. The Bluetooth wearable device 12 is worn by the baby. The positioning server 16 can determine whether the baby is still wearing the Bluetooth wearable device 12 or not by the temperature difference value of the temperature sensor 122 of the Bluetooth wearable device 12 and the temperature sensing module 181 of the ambient temperature sensor 18. The positioning server 16 issues an alarm and indicates the last position where the Bluetooth wearable device 12 is disengaged from the baby when the Bluetooth wearable device 12 is disengaged from the baby. In addition, a warning or prohibition area can be set in the hospital or post-natal care home. The positioning server 16 issues an alarm when the positioning server 16 detects that the Bluetooth wearable device 12 is approaching to or entering the warning or prohibition area.

In the above-mentioned embodiments, the Bluetooth module can be any Bluetooth protocol defined by the Bluetooth Association, such as a variety of Bluetooth devices likes Bluetooth 2.0 protocol, Bluetooth 3.0 protocol, or Bluetooth 4.0 protocol.

Compared with the prior art, the Bluetooth personnel location system of the present invention utilizes a Bluetooth wearable device to send a number of Bluetooth broadcasting signals and to calculate the location of the personnel based on the RSSI of the Bluetooth broadcasting signals, and determine the wearing conditions to ensure that the positioning results are correct by the temperature sensor in the Bluetooth wearable device.

With the examples and explanations mentioned above, the features and spirits of the invention are hopefully well described. More importantly, the present invention is not limited to the embodiment described herein. Those skilled in the art will readily observe that numerous modifications and alterations of the device can be made while retaining the teachings of the invention. Accordingly, the above disclosure should be construed as limited only by the metes and bounds of the appended claims.

What is claimed is:

1. A Bluetooth personnel location system, for positioning a coordinate position of a predetermined people, comprising:
a Bluetooth wearable device, worn by the predetermined people for sending a plurality of Bluetooth broadcasting signals, wherein, the Bluetooth wearable device comprises a temperature sensor and a heat conducting unit, and the heat conducting unit is used for contacting with the skin of the predetermined people, and the temperature sensor is used for measuring the temperature of the heat conducting unit to produce a temperature value;
a plurality of Bluetooth wireless base stations, for receiving the Bluetooth broadcasting signals and calculating a plurality of corresponding received signal strength indication according to the Bluetooth broadcasting signals, and sending the Bluetooth broadcasting signals and the received signal strength indication; and
a positioning server, for receiving the Bluetooth broadcasting signals and the received signal strength indication to calculate the coordinate position of the predetermined people.

2. The Bluetooth personnel location system of claim 1, wherein each Bluetooth broadcasting signal comprises a unique identification code of the Bluetooth wearable device and the temperature value measured by the temperature sensor.

3. The Bluetooth personnel location system of claim 2, wherein the positioning server determines that the Bluetooth wearable device is worn on the predetermined people according to whether the temperature value of the Bluetooth broadcasting signal is between a standard temperature range of human body.

4. The Bluetooth personnel location system of claim 2, wherein the positioning server determines that the Bluetooth wearable device is out of the predetermined people according to whether the temperature value of the Bluetooth broadcasting signal is beyond or below the standard temperature range of human body.

5. The Bluetooth personnel location system of claim 2, wherein the positioning server determines whether the Bluetooth wearable device is worn on or out of the predetermined people according to whether the temperature value of the Bluetooth broadcasting signal is between a range from the standard temperature range of human body adding an error of the temperature sensor and a temperature decay of the heat conducting unit to the standard temperature range of human body subtracting the error of the temperature sensor and the temperature decay of the heat conducting unit.

6. The Bluetooth personnel location system of claim 2, wherein the Bluetooth personnel location system further comprises an ambient temperature sensor, and the ambient temperature sensor comprises a temperature sensing module and a transmission module, and the temperature sensing module is used for sensing a room temperature value, and the transmission module is electrically connected to the temperature sensing module for transmitting the room temperature value to the positioning server.

7. The Bluetooth personnel location system of claim 6, wherein when the positioning server receives the temperature value measured by the temperature sensor of the Bluetooth wearable device and the room temperature value is close to a cumulative error range of the ambient temperature sensor and the temperature sensor of the Bluetooth wearable device, the positioning server determines that the Bluetooth wearable device is out of the predetermined people.

8. The Bluetooth personnel location system of claim 6, wherein the transmission module can be Bluetooth, Ethernet, Wi-Fi or wireless mobile communication module or other wired and wireless network module for communication.

9. The Bluetooth personnel location system of claim 1, wherein each Bluetooth wireless base station comprises a Bluetooth module and a network communication module, and each Bluetooth wireless base station receives the Bluetooth broadcasting signals sent from the Bluetooth wearable device via the Bluetooth module and calculates the Bluetooth broadcasting signals to produce the received signal strength indication, and transmits to the positioning server via the network communication module, and the network communication module can be Bluetooth, Ethernet, Wi-Fi or wireless mobile communication module or other wired and wireless network module for communication.
